(19) United States
(12) Patent Application Publication
(10) Pub. No.: US 2021/0356593 A1
(43) Pub. Date: Nov. 18, 2021

(54) DISTANCE MEASUREMENT SYSTEM AND METHOD FOR CALIBRATING DISTANCE MEASUREMENT SENSOR

(71) Applicant: Hitachi-LG Data Storage, Inc., Tokyo (JP)

(72) Inventors: Hisahiro HAYASHI, Tokyo (JP); Norimoto ICHIKAWA, Tokyo (JP)

(21) Appl. No.: 17/215,221

(22) Filed: Mar. 29, 2021

(30) Foreign Application Priority Data
May 14, 2020 (JP) 2020-085253

(51) Int. Cl. G01S 17/42; G01S 7/497; G01B 11/02; G01S 17/89; G01S 7/51; G01S 17/58

(52) U.S. Cl. CPC G01S 17/42; G01S 7/497; G01S 17/58; G01S 17/89; G01S 7/51; G01B 11/026

(57) ABSTRACT

There is provided a distance measurement system in which a plurality of distance measurement sensors are installed to generate a distance image of an object in a measurement region, the system including a cooperative processing device that performs alignment between the distance measurement sensors, and composes distance data from the plurality of distance measurement sensors to display the distance image of the object. In order to perform the alignment between the distance measurement sensors, trajectories (referred to as motion lines) of a person moving in the measurement region are acquired by the plurality of distance measurement sensors, and the cooperative processing device performs calibration of an installation position of each of the distance measurement sensors such that the motion lines acquired by the distance measurement sensors coincide with each other in a common coordinate system.

### CROSS-REFERENCE TO RELATED APPLICATION

The present application claims priority from Japanese application JP2020-085253, filed on May 14, 2020, the contents of which is hereby incorporated by reference into this application.

### BACKGROUND OF THE INVENTION

### 1. Field of the Invention

The present invention relates to a distance measurement system that uses a plurality of distance measurement sensors to measure a distance to an object, and a method for calibrating a distance measurement sensor.

### 2. Description of the Related Art

There is known a distance measurement sensor (hereinafter, also referred to as a time-of-flight sensor: TOF sensor) using a method for measuring the distance to an object based on the transmission time of light (hereinafter, TOF method). The movement path of, for example, a person or the like can be obtained by detecting the person or the like from the feature quantity of distance data acquired by the TOF sensor, and tracking a change over time of the person detected or the like. The principle of the TOF sensor is to measure the time from when irradiation light is emitted from a light source to when the irradiation light is reflected by the object to return to a light receiving unit, thus to calculate the distance to the object. Since there is a limit to the measurable distance and the viewing angle (angle of view) of one TOF sensor, when measurement in a wide space is performed, a plurality of the sensors are disposed to perform the measurement.

In this regard, for example, a distance image camera described in JP 2012-247226 A includes a plurality of camera units (TOF sensors) to be intended to have a wider angle of view than the angle of view of a single imaging unit, and to obtain a distance image having high distance accuracy. As the configuration, there is disclosed a configuration where “a two-dimensional position correction unit that corrects two-dimensional position information of each pixel based on the average distance information obtained by a distance information replacement unit and the two-dimensional pixel position of each pixel of each of the distance images, and a distance image composition unit that converts the two-dimensional position information of each pixel corrected by the two-dimensional position correction unit and the distance information in a common three-dimensional coordinate system, to obtain a composed distance image in which the distance images are composed are provided”.

JP 2012-247226 A describes that when the distance images of the camera units (TOF sensors) are coordinate-converted and composed, “the X value, the Y value, and the Z value of each pixel of each of the distance images are coordinate-converted in a camera coordinate system or a world coordinate system according to camera parameters (internal and external) obtained by calibration during installation of each camera unit 10, to compose a distance image”. As a general calibration technique, there is known a technique in which a specific object (marker) is disposed in a measurement space, the position of the marker is measured by each of the camera units (TOF sensors), and coordinate conversion is performed such that common coordinate values are obtained. However, in reality, it may be difficult to properly dispose the marker.

For example, it is known that a reflective tape made of a retroreflective material is used as the marker for calibration; however, an operation of affixing the reflective tape to the floor surface of a measurement site is needed. In the operation, the load on an operator increases as the number of the TOF sensors increases. Further, depending on the measurement environment, there may be irregularities or an obstacle on the floor surface, which makes it difficult to affix the reflective tape to a desired position.

In addition, in the technique described in JP 2012-247226 A, the distance images of the plurality of camera units are composed; meanwhile, the camera units are installed in the same direction as seen from an object (box), and the object (box) has a surface perpendicular to an irradiating direction of each of the camera units. For this reason, the image composition has a limited positional relationship, and calibration required for the image composition is also limited.

### SUMMARY OF THE INVENTION

An object of the present invention is to provide a distance measurement system and a calibration method capable of reducing the load on an operator in an operation of calibrating a distance measurement sensor, and easily executing calibration regardless of the measurement environment.

According to an aspect of the present invention, there is provided a distance measurement system in which a plurality of distance measurement sensors are installed to generate a distance image of an object in a measurement region, the system including: a cooperative processing device that performs alignment between the distance measurement sensors, and composes distance data from the plurality of distance measurement sensors to display the distance image of the object. In order to perform the alignment between the distance measurement sensors, trajectories (hereinafter, referred to as motion lines) of a person moving in the measurement region are acquired by the plurality of distance measurement sensors, and the cooperative processing device performs calibration of an installation position of each of the distance measurement sensors such that the motion lines acquired by the distance measurement sensors coincide with each other in a common coordinate system.

In addition, according to another aspect of the present invention, there is provided a method for calibrating a distance measurement sensor when a plurality of the distance measurement sensors are installed to generate a distance image of an object in a measurement region, in order to perform alignment between the distance measurement sensors, the method including: a step of detecting a person, who moves in the measurement region, with the plurality of distance measurement sensors to acquire trajectories (motion lines) of the person; and a step of performing calibration of sensor installation information of each of the distance measurement sensors such that the motion lines acquired by the distance measurement sensors coincide with each other in a common coordinate system.

The present invention provides the effects of reducing the load on an operator in an operation of calibrating the distance measurement sensor, and easily executing calibration regardless of the measurement environment.

### BRIEF DESCRIPTION OF THE DRAWINGS

FIG. 1 is a view illustrating a configuration of a distance measurement system according to the present embodiment;

FIG. 2 is a block diagram illustrating a configuration of a distance measurement sensor (TOF sensor);

FIG. 3 is a view describing the principle of distance measurement by a TOF method;

FIG. 4 is a block diagram illustrating a configuration of a cooperative processing device;

FIG. 5A is a view describing a calibration method using a reflective tape;

FIG. 5B is a view describing the calibration method using the reflective tape;

FIG. 6A is a view describing a calibration method using motion line data;

FIG. 6B is a view describing the calibration method using the motion line data;

FIG. 7 is a view illustrating an evaluation of the reliability of motion line data and an example of display thereof; and

FIG. 8 is a flowchart illustrating the procedure of a calibration process.

### DETAILED DESCRIPTION OF THE PREFERRED EMBODIMENTS

Hereinbelow, an embodiment of the present invention will be described. In the calibration of distance measurement sensors of the present embodiment, trajectory data (motion line data) of a person moving in a measurement space is acquired by each of the distance measurement sensors, and alignment (correction of installation position information) between the sensors is performed such that the trajectory data acquired by the distance measurement sensors coincide with each other in a common coordinate system.

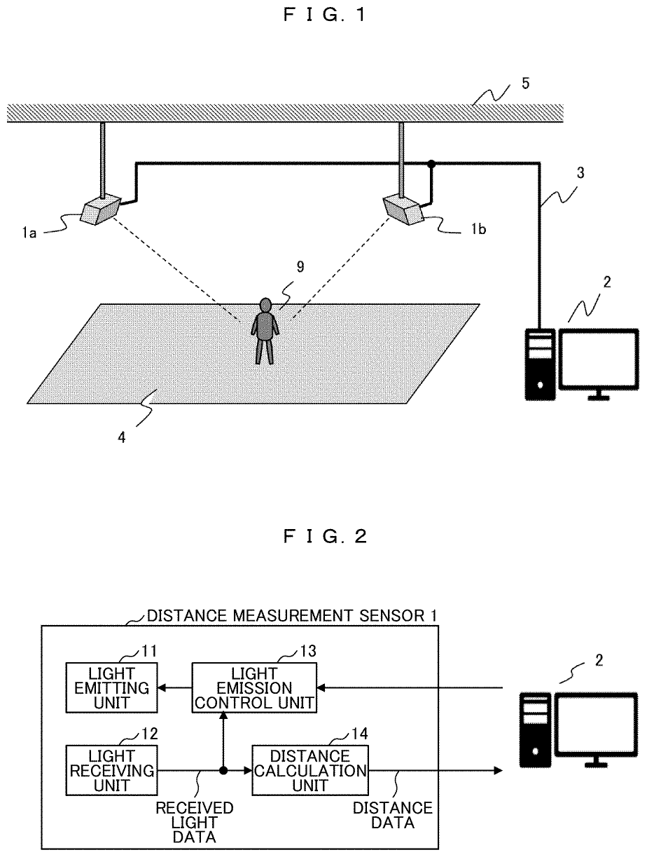

FIG. 1 is a view illustrating a configuration of a distance measurement system according to the present embodiment. In the distance measurement system, a plurality of distance measurement sensors (hereinafter, also referred to as “TOF sensors” or simply “sensors”) 1a and 1b and a cooperative processing device 2 that controls the distance measurement sensors are connected to each other by a network 3. The cooperative processing device 2 composes distance data acquired by sensors 1, to generate one distance image, and for this reason, performs a calibration process of correcting position information of each of the sensors 1. For example, a personal computer (PC) or a server is used as the cooperative processing device 2.

In the example illustrated in FIG. 1, two sensors 1a and 1b are attached to a ceiling 5, and measure the distance to an object 9 (here, a person), which is present on a floor surface 4, to create a distance image which is a movement trajectory (motion line) of the person 9. Since there is a limit to the measurable distance or the viewing angle of one sensor, a plurality of the sensors can be disposed not only to widen the measurement region, but also to accurately measure the position of the object 9. For that purpose, the coordinate conversion of the measured value of each of the sensors has to be accurately performed. Therefore, calibration between the sensors is needed.

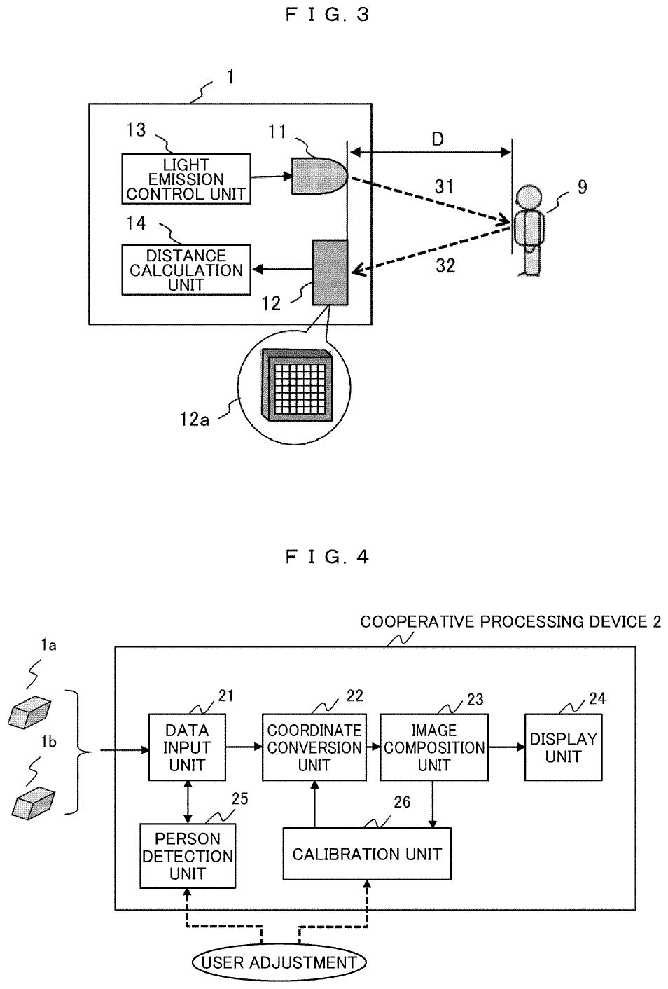

FIG. 2 is a block diagram illustrating a configuration of the distance measurement sensor (TOF sensor) 1. The distance measurement sensor 1 includes a light emitting unit that irradiates the object with pulsed infrared light from a light source such as a laser diode (LD) or a laser emitting diode (LED), a light receiving unit 12 that receives the pulsed light, which is reflected from the object, with a CCD sensor, a CMOS sensor or the like, a light emission control unit 13 that controls the turn on and off of the light emitting unit 11 and the amount of emitted light, and a distance calculation unit 14 that calculates the distance to the object from a detection signal (received light data) of the light receiving unit 12. Distance data calculated by the distance calculation unit 14 is transmitted to the cooperative processing device 2. In addition, the light emission control unit 13 of the distance measurement sensor 1 starts emitting light according to a measurement command signal from the cooperative processing device 2.

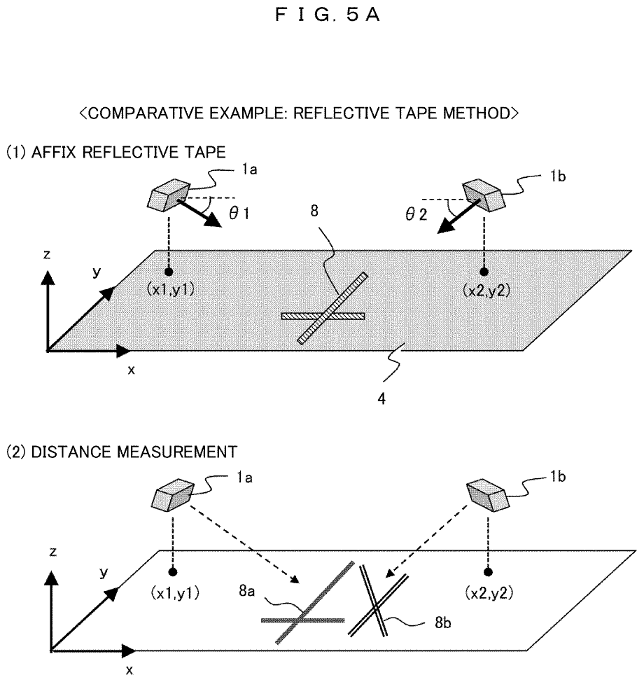

FIG. 3 is a view describing the principle of distance measurement by a TOF method. The distance measurement sensor (TOF sensor) 1 emits irradiation light 31 for measurement of the distance from the light emitting unit 11 toward the object (for example, a person). The light receiving unit 12 receives reflected light 32, which is reflected by the object 9, with a two-dimensional sensor 12a. The two-dimensional sensor 12a is configured such that a plurality of pixels such as CCD sensors are two-dimensionally arrayed, and the distance calculation unit 14 calculates two-dimensional distance data from received light data in each of the pixels.

The object 9 is present at a position spaced apart by a distance D from the light emitting unit 11 and the light receiving unit 12. Here, when the speed of light is c and the time difference from when the light emitting unit 11 emits the irradiation light 31 to when the light receiving unit 12 receives the reflected light 32 is t, the distance D to the object 9 is obtained by D=c×t/2. Incidentally, in practical distance measurement performed by the distance calculation unit 14, instead of using the time difference t, an irradiation pulse of a predetermined width is emitted, and the two-dimensional sensor 12a receives the irradiation pulse while shifting the timing of an exposure gate. Then, the distance D is calculated from the values of the amounts of received light (accumulated amount) at different timings (exposure gate method).

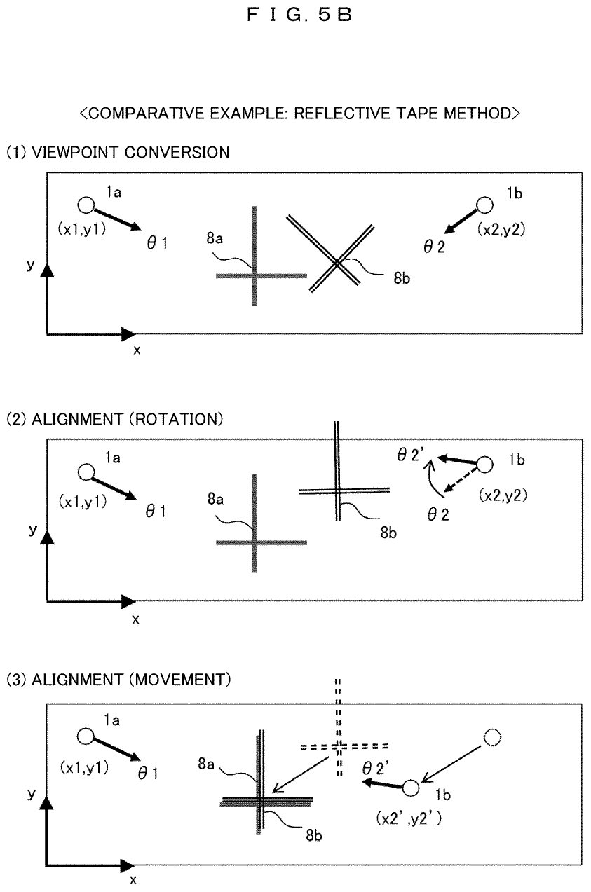

FIG. 4 is a block diagram illustrating a configuration of the cooperative processing device 2. The configuration of the cooperative processing device 2 includes a data input unit 21 into which the distance data from each of the distance measurement sensors 1a and 1b is input, a coordinate conversion unit 22 that converts the distance data, which is input, into position data in a common coordinate system, an image composition unit 23 that composes the position data to generate one distance image, and a display unit 24 that displays the composed distance image. Further, in order to perform calibration between the sensors 1a and 1b, a person detection unit 25 that detects a person (motion line), which is effective for the calibration, from the distance data input from each of the sensors, and a calibration unit 26 that corrects a conversion parameter (sensor installation information) to be used by the coordinate conversion unit 22, based on the result of the composed image, are provided. In addition, a transmission unit (not illustrated) which transmits a measurement instruction signal to each of the sensors 1a and 1b is provided.

In the cooperative processing device 2, arithmetic processing such as coordinate conversion, image composition, or calibration is performed, and a program used for the arithmetic processing is stored in a ROM, and the program is deployed to a RAM to be executed by a CPU, so that the above function is realized (not illustrated). Incidentally, regarding a person detection process and a calibration process, an operator (user) can also appropriately performs adjustment by using a user adjusting unit (not illustrated) while looking at an image of the motion line displayed on the display unit 24.

Next, a calibration method will be described. In the present embodiment, a motion line of a person is used as a measurement object (marker) for the calibration process; however, for comparison, first, a method using a reflective tape will be described.

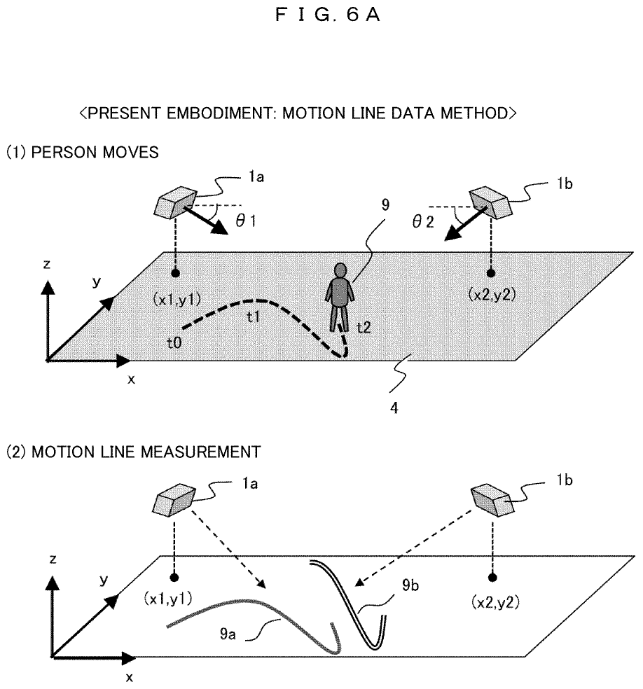

FIGS. 5A and 5B are views describing a calibration method using a reflective tape.

FIG. 5A(1) illustrates a state where a reflective tape 8 is disposed (affixed) on the floor surface 4 in a measurement space. The sensors 1a and 1b are installed at horizontal positions (x1, y1) and (x2, y2) of the measurement space (represented by xyz coordinates). The same installation height z is set for both for the sake of simplicity; however, even when the installation heights are different, a correction can be made by an arithmetic operation. Further, the azimuth angles of measurement directions (center directions of the viewing angles) of the sensors 1a and 1b are represented by θ1 and θ2. Incidentally, the angles of elevation and depression of both are the same; however, even when the angles of elevation and depression are different, a correction can be made by an arithmetic operation. The reflective tape 8 is made of a retroreflective material having a characteristic of reflecting incident light toward an incident direction and, for example, is affixed to the floor surface 4 in a cross shape.

FIG. 5A(2) illustrates a state where the distance to the reflective tape 8 is measured by the sensors 1a and 1b. The position of the reflective tape 8 measured by the sensor 1a is denoted by 8a, and the position of the reflective tape 8 measured by the sensor 1b is denoted by 8b (illustrated by double lines for distinction). The measured positions 8a and 8b are such that distance data obtained from the sensors is coordinate-converted using the installation positions (x1, y1) and (x2, y2) and the azimuth angles θ1 and θ2 of the sensors to be displayed on a common coordinate system, and are, so to speak, virtual measurement images of the reflective tape 8. Even for the same reflective tape 8, the measured positions (measurement images) may not coincide with each other as illustrated by 8a and 8b. The reason is that there is an error in information of the installation positions (x1, y1) and (x2, y2) and the azimuth angles θ1 and θ2 of the sensors. In addition, when there is an error in information of the installation heights or the angles of elevation and depression of the sensors, the measured positions 8a and 8b do not coincide with each other on the floor surface 4.

In the calibration process, the information of the installation position and the azimuth angle of the sensor is corrected such that the measured positions 8a and 8b of the reflective tape 8 coincide with each other. Then, coordinate conversion is performed based on the corrected installation information, and the virtual measurement images are displayed again. This process is repeated until the measured positions 8a and 8b coincide with each other. Hereinafter, the procedure of calibration will be described.

FIG. 5B(1) illustrates a state where viewpoint conversion is performed. Namely, the measured positions (measurement images) 8a and 8b on an x-y plane when the measurement space is seen from a z direction (directly above) are illustrated, and both deviate in position and direction from each other.

FIG. 5B(2) illustrates a state where the azimuth angle information of the sensor is rotated to be corrected for the alignment of the measured positions 8a and 8b. Here, the azimuth angle θ1 of the sensor 1a is fixed as it is, and the azimuth angle information of the sensor 1b is corrected from θ2 to θ2′, so that the directions (directions of the crosses) of the measured positions 8a and 8b coincide with each other.

FIG. 5B(3) illustrates a state where the position information of the sensor is moved to be corrected for the alignment of the measured positions 8a and 8b. The position (x1, y1) of the sensor 1a is fixed as it is, and the position information of the sensor 1b is corrected from (x2, y2) to (x2′, y2′), so that the measured positions 8a and 8b coincide with each other.

In the above calibration method using the reflective tape 8, an operation of affixing the reflective tape, which is a marker, to a measurement site is needed. At that time, when the number of the sensors increases, the load in the affixing operation increases, and depending on the measurement environment, the floor surface may not be flat or there may be an obstacle, so that it is difficult to affix the reflective tape. Therefore, the present embodiment is characterized in that not the reflective tape but motion line data of a moving person is used. Hereinafter, a calibration method using motion line data will be described.

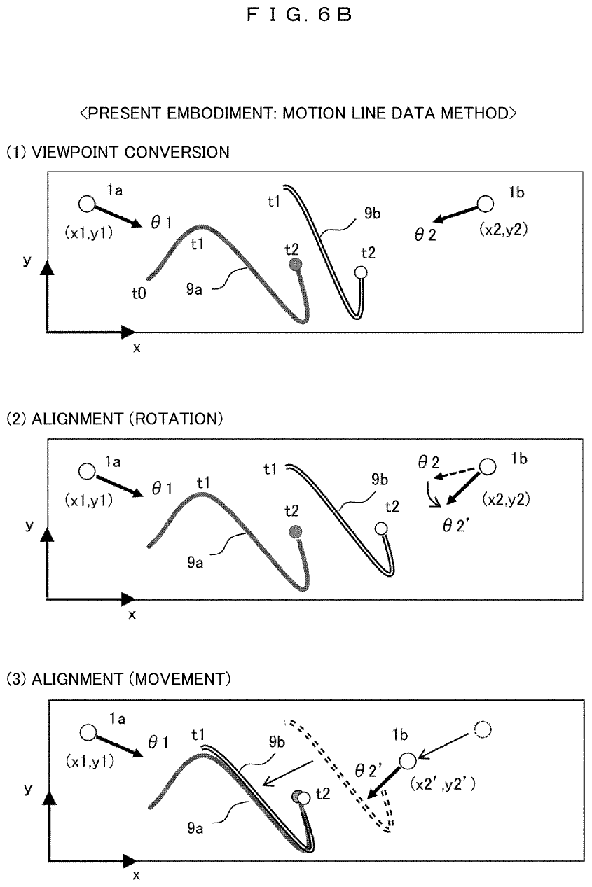

FIGS. 6A and 6B are views describing the calibration method using the motion line data.

FIG. 6A(1) illustrates a state where the person 9 moves on the floor surface 4 in the measurement space. Incidentally, the installation positions (x1, y1) and (x2, y2) and the measurement directions (azimuth angles) θ1 and θ2 of the sensors 1a and 1b are the same as those in FIG. 5A. The person is assumed to move on the floor surface 4 for time t0 to time t2 as illustrated by a broken line.

FIG. 6A(2) illustrates a state where the distance to the person 9 is measured by the sensors 1a and 1b. Incidentally, for example, a head is extracted from a person image, and the distance to the person 9 is represented by distance data to the head. Then, data of a movement trajectory (motion line) of the person 9 who has moved on the floor surface 4 is acquired. The motion line of the person 9 measured by the sensor 1a is denoted by 9a, and the motion line of the person 9 measured by the sensor 1b is denoted by 9b (illustrated by double lines for distinction). Even in this case, the motion lines 9a and 9b are such that the distance data obtained from the sensors is coordinate-converted using the installation positions (x1, y1) and (x2, y2) and the azimuth angles θ1 and θ2 of the sensors to be displayed on the common coordinate system, and are virtual measurement images of the motion lines of the person 9. In spite of the movement of the same person 9, the motion lines (measurement images) may not coincide with each other as illustrated by 9a and 9b. The reason is that there is an error in information of the installation positions (x1, y1) and (x2, y2) and the azimuth angles θ1 and θ2 of the sensors. In addition, when there is an error in information of the installation heights or the angles of elevation and depression of the sensors, the motion lines 9a and 9b do not coincide with each other on the floor surface.

In the calibration process, the information of the installation position and the azimuth angle of the sensor is corrected such that the motion lines 9a and 9b of the person 9 coincide with each other. Then, coordinate conversion is performed based on the corrected installation information, and the motion lines are displayed again. This process is repeated until the motion lines coincide with each other. Hereinafter, the procedure of calibration will be described.

FIG. 6B(1) illustrates a state where viewpoint conversion is performed. Namely, the motion lines 9a and 9b on the x-y plane when the measurement space is seen from the z direction (directly above) are illustrated, and both deviate in position and direction from each other. Incidentally, in this example, since start time t0 of the motion line 9a is different from start time t1 of the motion line 9b, the lengths of the motion lines are different.

FIG. 6B(2) illustrates a state where the azimuth angle information of the sensor is rotated to be corrected for the alignment of the motion lines 9a and 9b. Here, the azimuth angle θ1 of the sensor 1a is fixed as it is, and the azimuth angle information of the sensor 1b is corrected from θ2 to θ2′, so that the directions of the motion lines 9a and 9b coincide with each other. At that time, with reference to time information, a correction is made such that a common portion (namely, a section between times t1 and t2) of both the motion lines are parallel to each other.

FIG. 6B(3) illustrates a state where the position information of the sensor is moved to be corrected for the alignment of the motion lines 9a and 9b. The position (x1, y1) of the sensor 1a is fixed as it is, and the position information of the sensor 1b is corrected from (x2, y2) to (x2′, y2′), so that the motion lines 9a and 9b coincide with each other. In this example, the sections of the motion lines 9a and 9b between times t1 and t2 coincide with each other.

As described above, in the present embodiment, calibration is performed using the motion line data which is the movement trajectory of the person, and there is no need for the operator to affix the reflective tape to the floor surface as in the comparative example. Therefore, the load on the operator in the calibration operation can be reduced, and calibration can be easily executed regardless of the measurement environment. In addition, trajectory data for calibration of various shapes can be easily obtained, so that an improvement in accuracy of calibration can be expected.

In addition, in the present embodiment, since the motion line data of the head of the person is used, calibration can be performed at the height position of the head of the person. Therefore, as compared to the calibration on the floor surface to which the reflective tape is affixed as in the comparative example, the calibration method in the present embodiment is more proper as calibration in the case of the measurement object being a person, and a further improvement in accuracy can be expected.

In the present embodiment, in order to acquire the motion line data of a person, a specific person may move, and a method in which any person moves in the measurement space can also be used. Therefore, various motion line data can be obtained by the distance measurement sensors, and motion line data effective for calibration needs to be extracted from the various motion line data. In addition, a method for displaying the motion line data needs to be devised based on the assumption that the operator (user) may extract effective motion line data. In the present embodiment, the following processes are performed in consideration of the above situation.

(1) Body height information is acquired from distance data as accompanying information of persons detected, motion line data of persons having the same body height is extracted, and motion lines are aligned with each other. Accordingly, even when a large number of unspecific persons move in the measurement space, the measurement target can be narrowed down to the same person, and alignment can be performed.

(2) Referring to time information of when distance data is acquired, the time information being accompanying information of motion line data, motion lines are aligned with each other such that the positions of points on the motion lines coincide with each other, the times coinciding with each other at the points. Therefore, when the motion line data is displayed, animation display is performed with the times synchronized.

(3) The reliability of the motion line data is evaluated, and motion line data having high reliability is extracted. The reliability referred to here is the degree of measurement accuracy of the person data detected, and when a person is close to the sensor, a person has a large point cloud, and the direction of detection of a person is close to the center of the viewing angle, the person has high reliability. On the contrary, the more distant a person is from the sensor, the further the received light intensity of the TOF method at the position of an end portion of the viewing angle decreases and the reliability of the measured value decreases. Further, when the area of a person to be detected decreases, the point cloud (the number of the detection pixels of the light receiving unit) decreases, or when an obstacle is present in front of the person, a part of the motion line data is missing (hidden) (occurrence of occlusion), which is a concern, thereby causing a decrease in reliability. After the reliability of the motion line data is evaluated, the display unit 24 distinctively displays motion lines according to an evaluation result. For example, a motion line having high reliability is darkly displayed, and a motion line having low reliability is lightly displayed (alternatively, the display color may be changed).

(4) When motion line data of a plurality of the sensors is displayed on the display unit 24, the display of the motion line data can be turned on and off for each of the sensors. In addition, a plurality of motion line data measured in the past is saved, and desired data is read therefrom to be displayed. Calibration adjustment is performed using the plurality of data, so that the accuracy of calibration is improved.

The reliability of motion line data described in (3) will be described with reference to the drawing.

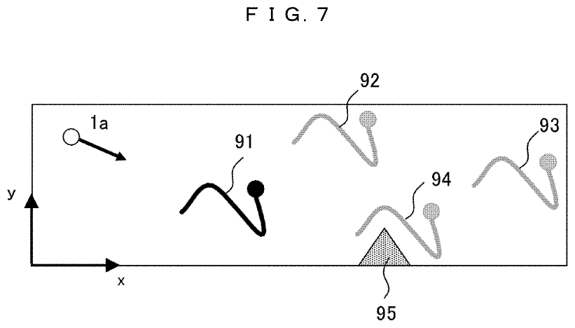

FIG. 7 is a view illustrating an evaluation of the reliability of motion line data and an example of display thereof. Four examples 91 to 94 measured by the sensor 1a are illustrated as the motion line data. The motion line 91 is located close to the sensor 1a, and the motion line 92 indicates a case where the detection position is located in an end portion of the viewing angle. In addition, the motion line 93 is located distant from the sensor 1a, and the motion line 94 indicates a case where an obstacle 95 is present in front of the movement path. As compared to the motion line 91 as a reference point, since the motion line 92 is located in the end portion of the viewing angle, the amount of received light is small, since the motion line 93 is located at a distant position, the point cloud is small, and the motion line 94 is a motion line of which a part is missing. Therefore, when the motion lines 91 to 94 are displayed, the motion line 91 having high reliability is darkly displayed, and the motion lines 92 to 94 having low reliability are lightly displayed. Alternatively, the motion lines may be displayed in a state where the colors of the motion lines are changed according to the reliability. Accordingly, the operator can select a motion line having high reliability from a plurality of motion lines, and use the motion line for calibration.

In addition, when motion line data is used, the shape of a motion line may also be taken into consideration. Namely, when the length of the motion line is short, it is difficult to align directions (rotation). Therefore, a predetermined length or more is needed. In addition, when the shape of the motion line is linear, alignment in a direction perpendicular thereto can be clearly performed, but alignment in a direction parallel thereto is unclear. Therefore, it can be said that the shape of the motion line is preferably curved, and the reliability is high.

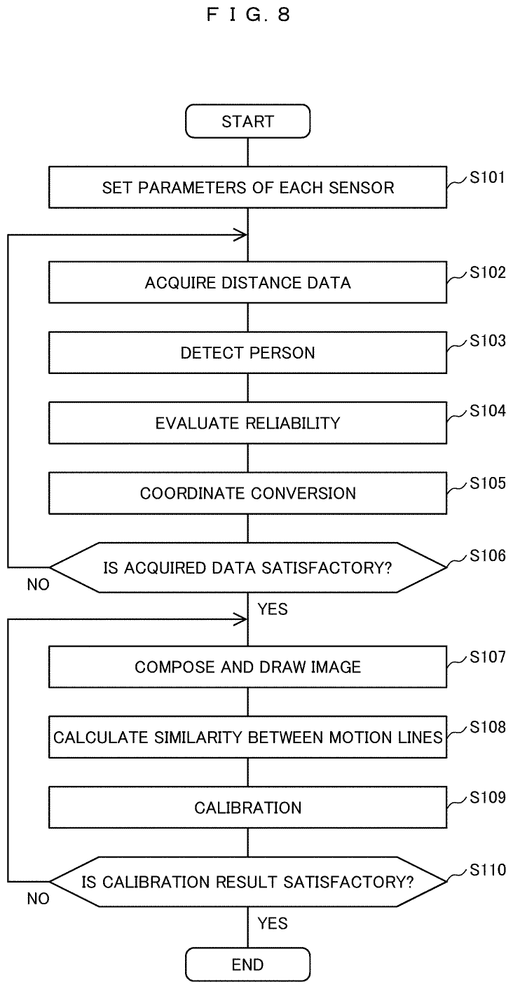

FIG. 8 is a flowchart illustrating the procedure of the calibration process of the present embodiment. The cooperative processing device 2 outputs an instruction to each of the distance measurement sensors to execute the calibration process. Hereinafter, the content of the process will be described in order of steps.

S101: The cooperative processing device 2 sets installation parameters of each of the distance measurement sensors 1. The installation parameters include the installation position (x, y, z), the measurement direction (azimuth angle) (θx, θy, θz) and the like of the sensor.

S102: Each of the sensors 1 acquires distance data in the measurement space over a predetermined time according to an instruction from the cooperative processing device 2, and transmits the distance data to the cooperative processing device 2.

S103: The person detection unit 25 of the cooperative processing device 2 detects a person from the received distance data. In the detection of the person, the position of the head of the person is detected by an image recognition technique. In addition, the time, the body height, the point cloud (the number of pixels included in a person region) and the like of the person detected are acquired and retained as accompanying information. When a plurality of persons are detected, position information or accompanying information of each of the persons is acquired.

S104: Further, the person detection unit 25 evaluates the reliability of the person detected (motion line data). The evaluation is an evaluation for extracting data having the highest accuracy for use in the calibration process, and conditions such as whether or not a person is close to the sensor, whether or not a person has a large point cloud, and whether or not the direction of detection is close to the center of the viewing angle are evaluated.

S105: The coordinate conversion unit 22 converts position data of the person, which is detected by each of the sensors, in a common coordinate space. In the coordinate conversion, the installation parameters set in S101 are used.

S106: It is determined whether or not the person data which is coordinate-converted is satisfactory. Namely, it is determined whether or not the accompanying information (time and body height) of the person detected by the sensors coincide with each other between the sensors. When the data is satisfactory, the process proceeds to S107, and when the data is not satisfactory, the process returns to S102, and distance data is acquired again.

S107: The image composition unit 23 composes the position data of the person from the sensors, which is coordinate-converted in S105, in the common coordinate space with the times synthesized, and draws the composed position data on the display unit 24. Namely, the motion lines acquired by the sensors are displayed. When a plurality of persons are detected, a plurality of sets of motion lines are displayed.

S108: The calibration unit 26 calculates a similarity between the motion lines acquired by the sensors. Namely, a place where the shapes (patterns) of the motion lines are similar to each other is extracted. For this reason, portions of the motion lines from the sensors, at which the times correspond to each other, are compared, and the similarity between the motion lines is obtained by a pattern matching method.

S109: The calibration unit 26 performs alignment (movement or rotation) on the sensors such that the motion lines coincide with each other in portions of the motion lines, which have high similarity (correspondence). Namely, the installation position and the measurement direction (azimuth angle) of the installation parameters of each of the sensors are corrected to (x′, y′, z′) and (θx′, θy′, θz′). Here, when there are a plurality (three or more) of the sensors, a sensor which serves as a reference point is determined, and the other sensors are aligned with the sensor one by one. Alternatively, other sensors which are not yet corrected are aligned in order with a sensor which has been already corrected.

S110: The motion line positions are coordinate-converted by the coordinate conversion unit 22 again, and the calibration result is drawn on the display unit 24. The operator looks at the motion line positions after correction, to determine whether or not the motion line positions are satisfactory. When the motion line positions are satisfactory, the calibration process ends, and when the motion line positions are not satisfactory, the process returns to S107, and alignment is repeatedly performed.

In the above flow, in the evaluation of the reliability in S104 and the calibration step of S109, the operator can also complementally perform alignment by using the user adjusting unit while looking at the motion lines displayed on the display unit 24. Namely, in S104, the operator determines the reliability of the motion lines to select a motion line having high reliability, so that the efficiency of the subsequent calibration process can be improved. In addition, in the calibration step of S109, the operator can manually fine-adjust the installation parameters to further improve the accuracy of the calibration process.

As described above, in the calibration of the distance measurement sensors of the present embodiment, the trajectory data (motion line data) of the person moving in the measurement space is acquired by each of the distance measurement sensors, and alignment (correction of the installation position information) between the sensors is performed such that the trajectory data acquired by the distance measurement sensors coincide with each other in the common coordinate system. Accordingly, the load on the operator in installing the marker (reflective tape) for the calibration operation can be reduced, and calibration can be easily executed regardless of the measurement environment.

1. A distance measurement system in which a plurality of distance measurement sensors are installed to generate a distance image of an object in a measurement region,
wherein the distance measurement sensor is of a type that measures a distance to the object based on a transmission time of light,
the system comprises a cooperative processing device that performs alignment between the distance measurement sensors, and composes distance data from the plurality of distance measurement sensors to display the distance image of the object, and
in order to perform the alignment between the distance measurement sensors, trajectories (hereinafter, referred to as motion lines) of a person moving in the measurement region are acquired by the plurality of distance measurement sensors, and the cooperative processing device performs calibration of an installation position of each of the distance measurement sensors such that the motion lines acquired by the distance measurement sensors coincide with each other in a common coordinate system.

2. The distance measurement system according to claim 1,
wherein the cooperative processing device includes a coordinate conversion unit that uses sensor installation information of the plurality of distance measurement sensors to convert the distance data from the plurality of distance measurement sensors into position data in the common coordinate system, an image composition unit that composes measurement data to generate one distance image, a display unit that displays the composed distance image, a person detection unit that detects the motion lines of the person, which are effective for the calibration, from the distance data input from the plurality of distance measurement sensors, and a calibration unit that corrects the sensor installation information to be used by the coordinate conversion unit, based on a result of the distance image in which the motion lines of the person are composed.

3. The distance measurement system according to claim 2,
wherein the person detection unit acquires body length information of the person as accompanying information of the person detected, and
when the motion lines of the person which are acquired by the plurality of distance measurement sensors are aligned with each other, the calibration unit calculates a similarity between the motion lines, and with reference to the body length information of the person, which is acquired by the person detection unit, and time information of when the distance data is acquired, performs alignment between the motion lines such that the body length information or the time information coincide with each other.

4. The distance measurement system according to claim 2,
wherein the person detection unit acquires distances from the distance measurement sensors to the person as accompanying information of the person detected, and evaluates reliability of the motions lines of the person detected, according to the distances from the distance measurement sensors to the person, and
the calibration unit performs alignment between the motion lines that are evaluated as having high reliability by the person detection unit.

5. The distance measurement system according to claim 2,
wherein the person detection unit acquires point clouds included in a person region, as accompanying information of the person detected, and evaluates reliability of the motion lines of the person detected, according to the point clouds included in the person region, and
the calibration unit performs alignment between the motion lines that are evaluated as having high reliability by the person detection unit.

6. The distance measurement system according to claim 2,
wherein the person detection unit acquires directions of detection of the person in viewing angles as accompanying information of the person detected, and evaluates reliability of the motion lines of the person detected, according to the directions of detection of the person in the viewing angles, and
the calibration unit performs alignment between the motion lines that are evaluated as having high reliability by the person detection unit.

7. The distance measurement system according to claim 2,
wherein the person detection unit acquires whether or not an obstacle is present in front of the person, as accompanying information of the person detected, and evaluates reliability of the motion lines of the person detected, according to whether or not the obstacle is present in front of the person, and
the calibration unit performs alignment between the motion lines that are evaluated as having high reliability by the person detection unit.

8. The distance measurement system according to claim 4,
wherein the motion lines are displayed on the display unit in a state where densities or colors of the motion lines are changed according to the reliability of the motion lines evaluated by the person detection unit.

9. The distance measurement system according to claim 5,
wherein the motion lines are displayed on the display unit in a state where densities or colors of the motion lines are changed according to the reliability of the motion lines evaluated by the person detection unit.

10. The distance measurement system according to claim 6, wherein the motion lines are displayed on the display unit in a state where densities or colors of the motion lines are changed according to the reliability of the motion lines evaluated by the person detection unit.

11. The distance measurement system according to claim 7, wherein the motion lines are displayed on the display unit in a state where densities or colors of the motion lines are changed according to the reliability of the motion lines evaluated by the person detection unit.

12. The distance measurement system according to claim 2, wherein a user adjusting unit is provided such that a user selects the motion lines, which are effective for the calibration, from the motion lines of the person which are detected by the person detection unit, and the user performs fine adjustment when the sensor installation information is corrected by the calibration unit.

13. A method for calibrating a distance measurement sensor when a plurality of the distance measurement sensors are installed to generate a distance image of an object in a measurement region,
wherein the distance measurement sensor is of a type that measures a distance to the object based on a transmission time of light, and
in order to perform alignment between the distance measurement sensors, the method comprises a step of detecting a person, who moves in the measurement region, with the plurality of distance measurement sensors to acquire trajectories (hereinafter, referred to as motion lines) of the person; and a step of performing calibration of sensor installation information of each of the distance measurement sensors such that the motion lines acquired by the distance measurement sensors coincide with each other in a common coordinate system.

14. The method for calibrating a distance measurement sensor according to claim 13,
wherein in the step of acquiring the motion lines, body length information of the person is acquired as accompanying information of the person detected, and
in the step of performing the calibration, a similarity between the motion lines acquired by the plurality of distance measurement sensors is calculated, and with reference to the body length information of the person detected and time information of when the distance is measured, alignment between the motion lines is performed such that the body length information or the time information coincide with each other.

15. The method for calibrating a distance measurement sensor according to claim 13,
wherein in the step of acquiring the motion lines, body length information of the person is acquired as accompanying information of the person detected, and
in the step of performing the calibration, a similarity between the motion lines acquired by the plurality of distance measurement sensors is calculated, and with reference to the body length information of the person detected and time information of when the distance is measured, alignment between the motion lines is performed such that the body length information or the time information coincide with each other.

16. The method for calibrating a distance measurement sensor according to claim 13,
wherein in the step of acquiring the motion lines, point clouds included in a person region are acquired as accompanying information of the person detected, and reliability of the motion lines of the person detected is evaluated according to the point clouds included in the person region, and
in the step of performing the calibration, alignment between the motion lines that are evaluated as having high reliability in the step of acquiring the motion lines is performed.

17. The method for calibrating a distance measurement sensor according to claim 13,
wherein in the step of acquiring the motion lines, directions of detection of the person in viewing angles are acquired as accompanying information of the person detected, and reliability of the motion lines of the person detected is evaluated according to the directions of detection of the person in the viewing angles, and
in the step of performing the calibration, alignment between the motion lines that are evaluated as having high reliability in the step of acquiring the motion lines is performed.

18. The method for calibrating a distance measurement sensor according to claim 13,
wherein in the step of acquiring the motion lines, whether or not an obstacle is present in front of the person is acquired as accompanying information of the person detected, and reliability of the motion lines of the person detected is evaluated according to whether or not the obstacle is present in front of the person, and
in the step of performing the calibration, alignment between the motion lines that are evaluated as having high reliability in the step of acquiring the motion lines is performed.
